(19) United States
(12) Patent Application Publication
(10) Pub. No.: US 2016/0306505 A1
(43) Pub. Date: Oct. 20, 2016

(54) COMPUTER-IMPLEMENTED METHODS AND SYSTEMS FOR AUTOMATICALLY CREATING AND DISPLAYING INSTANT PRESENTATIONS FROM SELECTED VISUAL CONTENT ITEMS

(71) Applicant: Avincel Group, Inc., Cambridge, MA (US)

(72) Inventors: Aymeric Vigneras, Belmont, MA (US); Etienne Leroy, Arlington, MA (US); Vincent Rabeux, Brookline, MA (US)

(73) Assignee: Avincel Group, Inc., Cambridge, MA (US)

(21) Appl. No.: 15/130,366

(22) Filed: Apr. 15, 2016

Related U.S. Application Data
(60) Provisional application No. 62/149,282, filed on Apr. 17, 2015.

(51) Int. Cl. G06F 3/0481; G06F 3/0484; G06F 1/16

(52) U.S. Cl. CPC G06F 3/0481; G06F 1/163; G06F 3/04842

(57) ABSTRACT

A computer-implemented method is disclosed for automatically creating an instant presentation to be displayed to user on a user device. The method includes the steps of: (a) selecting, by a computer processor, a set of content items determined to be relevant to the user at a particular moment in time from a multimedia library of content assets; (b) creating, by the computer processor, an instant presentation using said set of content items; and (c) transmitting, by the computer processor, said presentation to a display of the user device to be shown to the user.

### CROSS REFERENCE TO RELATED APPLICATION

This application claims priority from U.S. Provisional Patent Application No. 62/149,282 filed on Apr. 17, 2015 entitled COMPUTER-IMPLEMENTED METHODS AND SYSTEMS FOR AUTOMATICALLY CREATING AND DISPLAYING INSTANT PRESENTATIONS FROM SELECTED VISUAL CONTENT ITEMS, which is hereby incorporated by reference.

### BACKGROUND

The present application relates generally to the field of media presentations and, more particularly, to computer-implemented methods and systems for selecting visual content items from a plurality of such items and automatically creating and displaying instant presentations such as picture and video slideshows and video montages.

A “presentation,” as used herein, refers to the display of content items to a user on a user device. Using software on the user device, images, text, videos, and other multimedia assets can be presented to the user on different frames (e.g., pages or slides). The transitions between these frames, or the frames themselves, can be animated by the software and can be set to music. Slideshows, video-slideshows, or video montages are ways of displaying a set of multimedia assets in an engaging manner to users.

As a result of massive sales of smartphones equipped with cameras over the last decade, consumers are collecting and taking increasingly large numbers of pictures and videos. For example, families today tend to take hundreds, if not thousands, of pictures and videos each month. Their resulting multimedia libraries are now so large that users find it difficult and tedious to navigate and view their own pictures, videos, and other multimedia creations. It would be desirable for users to have engaging tools for presenting their multimedia assets stored on computers, smartphones, and the cloud.

Some existing tools attempt to display these large collections of images, videos, and audio in a more cohesive form. For example, smartphones like those from Apple (on their iOS offerings) show large clusters of media as tiles, and use appropriate gestures to allow the users to navigate through their collections. Some other tools use more complex classification algorithms (using different criteria such as time, location and similarity) to build navigable graphs of assets. However, these tools, even with the most sophisticated animations, are not engaging as they do not automatically select and present relevant multimedia assets directly to the user, and moreover they are not instant.

### BRIEF SUMMARY OF THE DISCLOSURE

A computer-implemented method in accordance with one or more embodiments is provided for automatically creating an instant presentation to be displayed to user on a user device. The method includes the steps of: (a) selecting, by a computer processor, a set of content items determined to be relevant to the user at a particular moment in time from a multimedia library of content assets; (b) creating, by the computer processor, an instant presentation using said set of content items; and (c) transmitting, by the computer processor, said presentation to a display of the user device to be shown to the user.

A computer system operated by a user in accordance with one or more further embodiments, comprises at least one processor, memory associated with the at least one processor, a display, and a program supported in the memory for automatically creating an instant presentation to be displayed to the user. The program contains a plurality of instructions which, when executed by the at least one processor, cause the at least one processor to: (a) select a set of content items determined to be relevant to the user at a particular moment in time from a multimedia library of content assets; (b) create an instant presentation using said set of content items; and (c) transmit said presentation to the display to be shown to the user.

A computer program product in accordance with one or more embodiments is provided for automatically creating an instant presentation to be displayed to user on a user device. The computer program product resides on a non-transitory computer readable medium having a plurality of instructions stored thereon which, when executed by a computer processor, cause that computer processor to: (a) select a set of content items determined to be relevant to the user at a particular moment in time from a multimedia library of content assets; (b) create an instant presentation using said set of content items; and (c) transmit said presentation to a display of the user device to be shown to the user.

### BRIEF DESCRIPTION OF THE DRAWINGS

FIG. 1 is a flow diagram illustrating an exemplary process for creating an instant presentation in accordance with one or more embodiments.

FIG. 2 is a flow diagram illustrating an exemplary process for selecting relevant assets for a user at a specific moment in time, from different sources of content in accordance with one or more embodiments.

FIG. 3 is a simplified block diagram illustrating an exemplary user device in accordance with one or more embodiments.

### DETAILED DESCRIPTION

Various embodiments disclosed herein relate to a computer software system providing users with an engaging tool for abstracting both the search and the viewing of relevant multimedia assets. Users can use an application (desktop or embedded) on a user device to automatically generate and display a relevant presentation (e.g., a picture slideshow, a video-slideshow, or a video montage) from automatically selected visual content items (e.g., pictures, video segments, or generally any graphical assets) from the user's media library instantly (i.e., within a few seconds) when the application is launched.

FIG. 1 illustrates an exemplary three step process for generating such an instant-presentation. As shown in FIG. 1, the first step is to define what is relevant for the user at a particular moment in time, in the form of a “category of interest.” The second step is to use the information from the first step to identify multimedia assets that are relevant. The third step is to create the instant presentation of the relevant multimedia assets and to display it immediately.

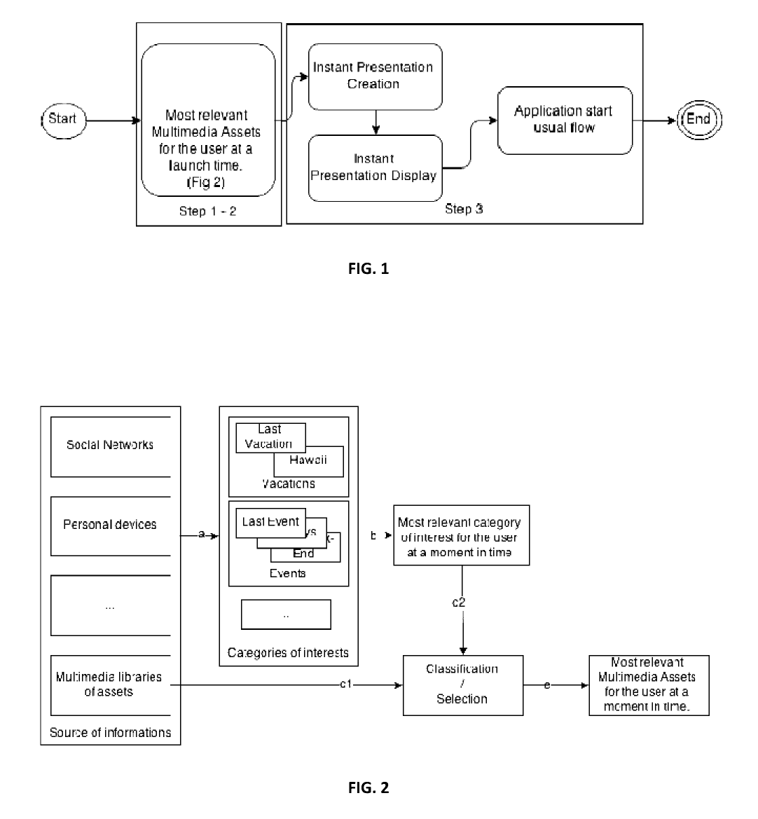

A category of interest is a set of information that reflects the user's specific interests. Non-limiting examples of categories of interest include the user's last vacation, the user's last photo shoot, last weekend, and the user's family whereabouts, photos, and posts on social networks. As shown in FIG. 2, using various machine learning and classification algorithms (transition a) and the information left by the user on social networks, user photo libraries, or elsewhere, content can be generally labeled into different categories of interest. The relevance (at a moment in time) of a category of interest can be measured by the amount of information that indicates the accuracy of that particular moment. For example, a point system can be used based on factors like time, location, and subject. In this way, the system defines for a specific user at a specific time, what is his or her most relevant category of interest (transition b), and thereby predict what he or she finds interesting.

An appropriate clustering or classification algorithm can be used to label a multimedia asset with the corresponding category of interest (transition c2). The second step of the process is to apply the corresponding classification algorithm to the user's multimedia library (transition c1). Multimedia assets labeled with the desired category of interest (transition e) constitute a first set of assets. On the latter, a choice of selection algorithms (depending on the need) can be applied that will select a subset of these assets. For example, the algorithm may discard all blurry images from the set. The resulting selection of media will be used to create the instant presentation (transition e).

Once step 2 is over, a relevant set of multimedia assets has been obtained. These assets can be used to create a relevant instant presentation. This presentation is displayed immediately as the user opens the application.

U.S. patent application Ser. No. 14/540,814 entitled COMPUTER-IMPLEMENTED METHODS AND SYSTEMS FOR CREATING MULTIMEDIA ANIMATION PRESENTATIONS illustrates exemplary techniques for creating multimedia animation presentations from visual content items, and is incorporated by reference herein.

An instant presentation can be saved on a computer server system and/or locally on the user device. Users can share the instant presentations privately or publicly with individuals or groups by various means, including, e.g., emails and social networking sites like Facebook, Twitter, Viber, etc.

The instant presentation system may be implemented in stand-alone software on the user device operated by the user, but may also be implemented in the context of a computer server system (distributed environment), in which one or more servers communicate with the user device.

In the context of a computer server system, the user devices communicate with the system over a communications network. The communications network may comprise any network or combination of networks including, without limitation, the Internet, local area networks, wide area networks, wireless networks, cellular networks, or device-internal networks.

The user devices operated by users in the context of a stand-alone software or a computer server system can comprise any computing device, including, without limitation, smart phones (e.g., the Apple iPhone and Android-based smart phones), wearable smart devices (e.g., smart watches), tablet computers (e.g., the Apple iPad tablet), personal computers, smart TVs, game devices, cell phones, and personal digital assistants. The devices include operating systems (e.g., Android, Apple iOS, and Windows Phone OS, among others) on which applications run.

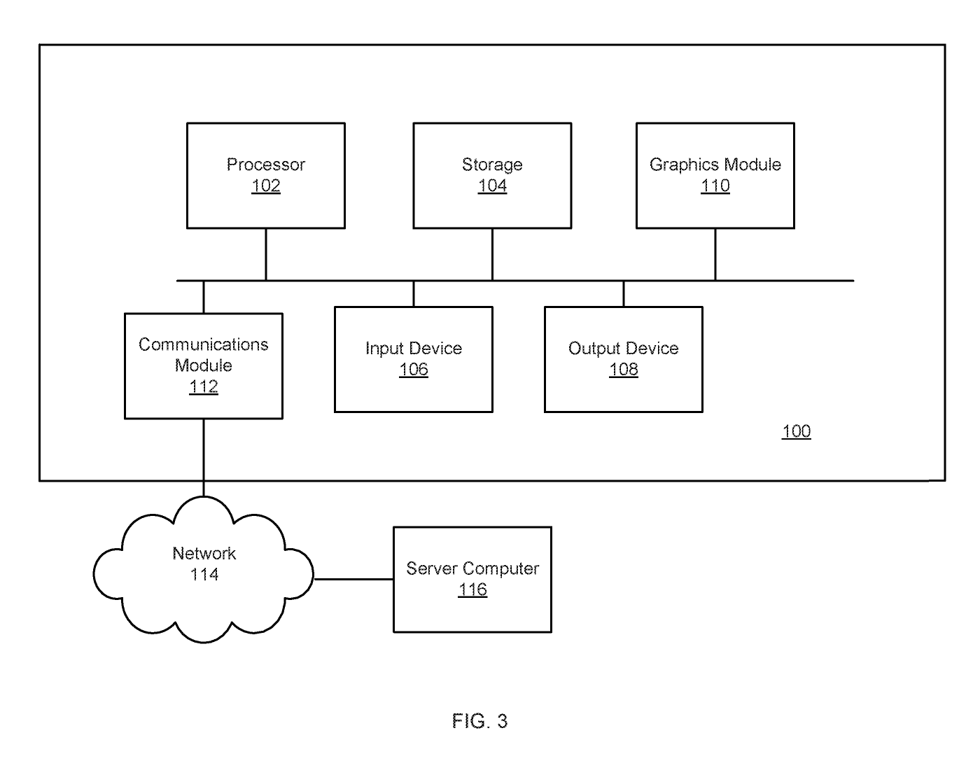

FIG. 3 illustrates a representative user computer device 100 in accordance with one or more embodiments. The device 100 includes at least one computer processor 102 and a storage medium 104 readable by the processor 102 for storing applications and data including content items. The device 100 also includes input/output devices 106, 108 such as, e.g., a camera, one or more speakers for acoustic output, a microphone for acoustic input, and a display for visual output. The device also includes a graphics module for generating graphical objects. The device may also include a communication module or network interface 112 to communicate with a computer server 116 or other devices via telecommunications and other networks 114.

The processes of the instant presentation system described above may be implemented in software, hardware, firmware, or any combination thereof. The processes are preferably implemented in one or more computer programs executing on a programmable computer (which can be part of the computer server system or a user device) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network or not connected.

Accordingly, the foregoing description and drawings are by way of example only, and are not intended to be limiting.

1. A computer-implemented method for automatically creating an instant presentation to be displayed to user on a user device, comprising the steps of:
(a) selecting, by a computer processor, a set of content items determined to be relevant to the user at a particular moment in time from a multimedia library of content assets;
(b) creating, by the computer processor, an instant presentation using said set of content items; and
(c) transmitting, by the computer processor, said presentation to a display of the user device to be shown to the user.

2. The method of claim 1, wherein the computer processor is part of the user device.

3. The method of claim 1, wherein the computer processor is part of a computer server system communicating with the user device over a communications network.

4. The method of claim 1, wherein the presentation is a picture or video slideshow or montage.

5. The method of claim 1, wherein the set of content items includes images, text, and/or videos, that can be presented on different frames.

6. The method of claim 1, wherein the user device comprises a personal computer, a smartphone, a wearable device, a television, or a personal digital assistant.

7. The method of claim 1, wherein the multimedia library of content assets is stored on the user device and/or in the cloud.

8. The method of claim 1, wherein the presentation is automatically created in real-time upon launch of a given application on the user device.

9. The method of claim 1, wherein step (a) comprises identifying different categories of interests for the user based on content captured by the user device, geographic locations of the user device, or posts on social networks by the user; identifying a relevant category of interest for the user at a particular time; and selecting a subset of content assets from a multimedia library of assets based on the relevant category of interest.

10. A computer system operated by a user, comprising:
at least one processor;
memory associated with the at least one processor;
a display; and
a program supported in the memory for automatically creating an instant presentation to be displayed to the user, the program containing a plurality of instructions which, when executed by the at least one processor, cause the at least one processor to:
(a) select a set of content items determined to be relevant to the user at a particular moment in time from a multimedia library of content assets;
(b) create an instant presentation using said set of content items; and
(c) transmit said presentation to the display to be shown to the user.

11. The system of claim 10, wherein the presentation is a picture or video slideshow or montage.

12. The system of claim 10, wherein the set of content items includes images, text, and/or videos, that can be presented on different frames.

13. The system of claim 10, wherein the computer system comprises a personal computer, a smartphone, a wearable device, a television, or a personal digital assistant.

14. The system of claim 10, wherein the multimedia library of content assets is stored on the computer system and/or in the cloud.

15. The system of claim 10, wherein the presentation is automatically created in real-time upon launch of the program on the computer system.

16. The system of claim 10, (a) comprises identifying different categories of interests for the user based on content captured by the user device, geographic locations of the user device, or posts on social networks by the user; identifying a relevant category of interest for the user at a particular time; and selecting a subset of content assets from a multimedia library of assets based on the relevant category of interest.

17. A computer program product for automatically creating an instant presentation to be displayed to user on a user device, said computer program product residing on a non-transitory computer readable medium having a plurality of instructions stored thereon which, when executed by a computer processor, cause that computer processor to:
(a) select a set of content items determined to be relevant to the user at a particular moment in time from a multimedia library of content assets;
(b) create an instant presentation using said set of content items; and
(c) transmit said presentation to a display of the user device to be shown to the user.

18. The computer program product of claim 17, wherein the computer processor is part of the user device.

19. The computer program product of claim 17, wherein the computer processor is part of a computer server system communicating with the user device over a communications network.

20. The computer program product of claim 17, wherein (a) comprises identifying different categories of interests for the user based on content captured by the user device, geographic locations of the user device, or posts on social networks by the user; identifying a relevant category of interest for the user at a particular time; and selecting a subset of content assets from a multimedia library of assets based on the relevant category of interest.
